(19) United States
(12) Patent Application Publication
(10) Pub. No.: US 2013/0067406 A1
(43) Pub. Date: Mar. 14, 2013

(54) DISPLAY SYSTEM, IMAGE DATA OBTAINING METHOD, AND RECORDING MEDIUM

(71) Applicant: Tomohiro Yoshimura, Osaka-shi (JP)

(72) Inventor: Tomohiro Yoshimura, Osaka-shi (JP)

(73) Assignee: Sharp Kabushiki Kaisha, Osaka (JP)

(21) Appl. No.: 13/608,465

(22) Filed: Sep. 10, 2012

(30) Foreign Application Priority Data
Sep. 12, 2011 (JP) 2011-198631

(51) Int. Cl. G06F 3/048

(52) U.S. Cl. 715/810

(57) ABSTRACT

In a display system comprising a plurality of electric devices spatially separated from each other, and a display section which displays images based on image data obtained from the electric devices, a menu screen representing functions of the plurality of electric devices is displayed on the display section, selection of any one of the functions is accepted via the menu screen, and image data is obtained from any one of the electric devices based on the accepted selection, and is displayed on the display section.

### CROSS-REFERENCE TO RELATED APPLICATIONS

This non-provisional application claims priority under 35 U.S.C. §119(a) on Patent Application No. 2011-198631 filed in Japan on Sep. 12, 2011, the entire contents of which are hereby incorporated by reference.

### FIELD

The present invention relates to a display system which comprises a display section and a plurality of electric devices spatially separated from each other, and which displays an image based on image data obtained from any one of the electric devices on the display section, an image data obtaining method using the display system and a recording medium for a computer constituting the display system.

### BACKGROUND

In recent years, various electric devices which are useful for people's life become widely used with the technical development. Many of such electric devices comprise a display section for accepting an instruction from a user in order to improve convenience for use.

For example, Japanese Patent Application Laid-Open No. H11-85257 (1999) discloses a malfunction monitoring device in which a plurality of controllers are connected in parallel with one display apparatus, are provided with motion picture cameras and infrared cameras as a two-dimensional sensor and with an acoustic sensor, a vibration sensor, a temperature sensor, or distance sensor as a one-dimensional sensor, and monitor a malfunction based on a plurality of items of image information and a plurality of items of sensor information.

On the other hand, Japanese Patent Application Laid-Open No. H09-298927 (1997) discloses an integrated display apparatus of a mobile agricultural machinery in which a plurality of controllers for various controls are connected to a single display at a loop, and functions of the plurality of controllers are displayed on the single display so as to be switchable.

### SUMMARY

For example, a convenience store provides electronic devices such as a ticketing device for various kinds of tickets, a scanner, a copy machine, and a printer, and each of the electronic devices is provided with a display section serving as an operation panel.

On the other hand, it is hard to assume that one user uses a plurality of electronic devices simultaneously when the one user uses the plurality of electronic devices, and the one user will use the electronic devices in predetermined order.

That is, when a user operates a plurality of electronic devices which are arranged separately from each other, the user has to move to positions at which the electronic devices are arranged, and operate the electronic devices while recognizing the display sections visually, which means that the user has to do a troublesome task. However, the above-described malfunction monitoring device disclosed in Japanese Patent Application Laid-Open No. H11-85257 (1999), and the above-described integrated display apparatus of the mobile agricultural machinery disclosed in Japanese Patent Application Laid-Open No. H09-298927 (1997) cannot solve such a problem.

The present invention has been made with the aim of solving the above problem, and it is an object of the invention to provide a display system comprising a plurality of electric devices spatially separated from each other and a display section for displaying an image based on image data obtained from the electric devices, in which a function display screen for representing functions of the plurality of electric devices is displayed on the display section, selection of any one of the functions is accepted via the function display screen, and image data is obtained from any one of the electric devices based on the accepted selection and is sent to the display section, thereby different kinds of electronic devices which are arranged separately from each other can share one display section and a user's troublesome task as described above can be omitted, and, an image data obtaining method using the display system and a recording medium for a computer constituting the display system.

The display system according to the present invention is a display system comprising a plurality of electric devices spatially separated from each other, and a display section which displays images based on image data obtained from the electric devices, wherein the display section displays a function display screen representing functions of the plurality of electric devices, the display system further comprises: a selection accepting section which accepts selection of any one of the functions through the function display screen; and an image obtaining section which is located between the display section and the plurality of electric devices, and obtains image data from any one of the electric devices based on the selection accepted by the selection accepting section.

In the present invention, the function display screen is displayed on the display section, and the selection accepting section accepts selection of any one of the functions from a user through the function display screen. In this case, the image obtaining section obtains image data from any one of the electric devices based on the selection accepted by the selection accepting section, and sends the obtained image data to the display section.

The display system according to the present invention is characterized by further comprising a notifying section which notifies the electric device from which the image obtaining section obtains image data at the moment, of the function concerning the selection accepted by the selection accepting section, wherein each of the electric devices is provided with an instructing section which instructs the image obtaining section to stop obtaining image data when the electric device accepts the notification and the notification does not correspond to its own function.

In the present invention, in a case where a function concerning the accepted selection does not correspond to a function of the electric device which is a current source for obtaining image data when the selection accepting section has accepted selection of any one of the functions from a user via the function display screen, the electric device transmits to the image obtaining section an instruction to stop obtaining image data. Said image obtaining section which has received the instruction stops obtaining image data from the electric device which is the current source for obtaining image data, and changes the source for obtaining image data to a new source based on the selection accepted by the selection accepting section.

The image data obtaining method according to the present invention is a method of obtaining image data to be displayed in a display system comprising a plurality of electric devices spatially separated from each other, a display section which displays images based on image data obtained from the electric devices, and an image obtaining section which is located between the display section and the plurality of electric devices and obtains image data from any one of the electric devices, said method comprising: a step of displaying a function display screen representing functions of the plurality of electric devices on the display section; a selection accepting step of accepting selection of any one of the functions through the function display screen; and a step of the image obtaining section obtaining image data from any one of the electric devices, based on the selection accepted at the selection accepting step.

The recording medium according to the present invention is a computer-readable recording medium in which a computer program is recorded, the computer program causing, to obtain image data to be displayed, a computer constituting a display system comprising a plurality of electric devices spatially separated from each other, a display section which displays images based on image data obtained from the electric devices, and an image obtaining section which is located between the display section and the plurality of electric devices and obtains image data from any one of the electric devices, said computer program comprising: a step of causing the computer to display a function display screen representing functions of the plurality of electric devices on the display section; a selection accepting step of causing the computer to accept selection of any one of the functions through the function display screen; and a step of causing the computer to obtain image data through the image obtaining section from any one of the electric devices, based on the selection accepted at the selection accepting step.

In the present invention, said function display screen is displayed on said display section, and selection of any one of the functions is accepted from a user through the function display screen. In this case, the image obtaining section obtains image data from any one of the electric devices based on the accepted selection, and sends the obtained image data to the display section.

In the present invention, the above-described computer program is recorded on said recording medium. A computer reads said computer program from said recording medium, and the above-described display system and image data obtaining method are realized by the computer.

According to the present invention, different kinds of electronic devices which are arranged separately from each other can share one display section, and when a user operates a plurality of electronic devices which are arranged separately from each other, a user's troublesome task of moving to positions at which the electronic devices are arranged, respectively, can be omitted.

The above and further objects and features will more fully be apparent from the following detailed description with accompanying drawings.

### BRIEF DESCRIPTION OF THE DRAWINGS

FIG. 1 is a functional block diagram showing an essential configuration of a display system according to Embodiment 1 of the present invention.

FIG. 2 is a functional block diagram showing an essential configuration of a display apparatus of the display system according to Embodiment 1 of the present invention.

FIG. 3 is a flow chart explaining how to obtain image data in the display system according to Embodiment 1 of the present invention.

FIG. 4 is an explanatory diagram showing a case in which an image obtaining section of the display apparatus obtains image data from a printer in the display system according to Embodiment 1 of the present invention.

FIG. 5 is a diagram showing a selection operation of a function on a menu screen in Embodiment 1 of the present invention.

FIG. 6 is an explanatory diagram showing a case in which the image obtaining section of the display apparatus obtains image data from a scanner in the display system according to Embodiment 1 of the present invention.

FIG. 7 is a functional block diagram showing an essential configuration of a display apparatus of a display system according to Embodiment 2 of the present invention.

### DETAILED DESCRIPTION OF NON-LIMITING EXAMPLE EMBODIMENTS

The following description will explain an example in which a display system according to Embodiment of the present invention comprises a printer 10, a display apparatus 20, and a scanner 30, based on the drawings in detail.

### Embodiment 1

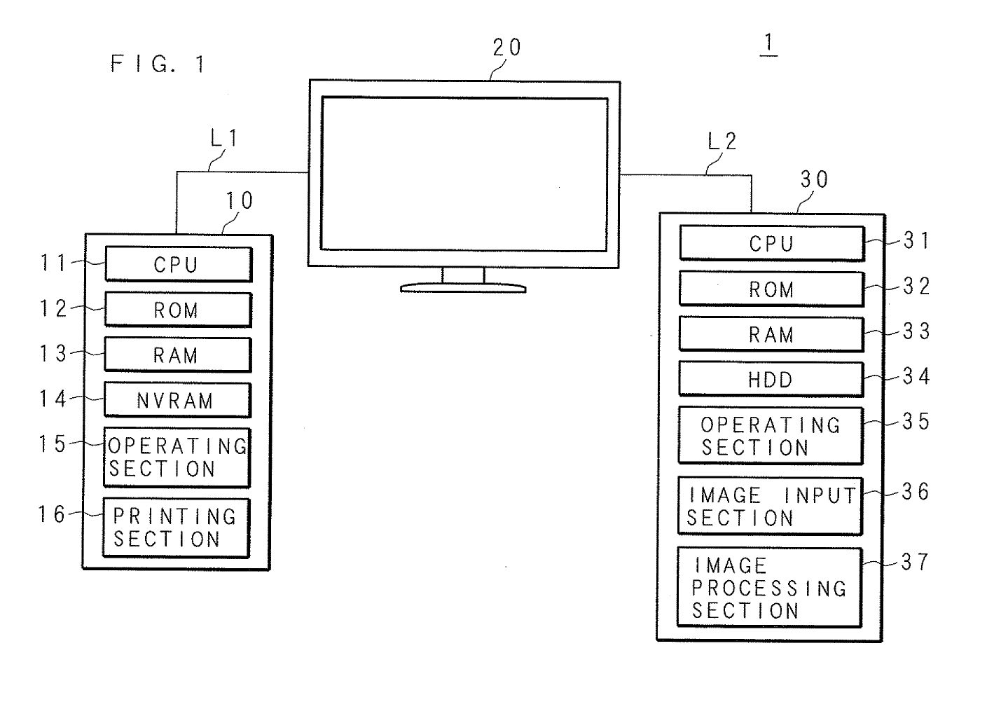

FIG. 1 is a functional block diagram showing an essential configuration of a display system 1 according to Embodiment 1 of the present invention. The display system 1 comprises a printer 10 (electric device), a display apparatus 20, and a scanner 30 (electric device).

The printer 10 is provided with a CPU 11, a ROM 12, a RAM 13, an NVRAM 14, an operating section 15, and a printing section 16.

The ROM 12 stores basically fixed data etc. of various kinds of control programs and parameters for operations in advance, and the RAM 13 is capable of storing data temporarily and allows the data to be read regardless of the order and place they are stored. The RAM 13 stores, for example, a program read from the ROM 2, various kinds of data generated by the execution of the program and parameters varying appropriately in a case of the execution, and the like.

The CPU 11 (instructing section) loads on the RAM 13 the control program stored in the ROM 12 in advance and executes it, to control the above-described various hardware devices, and operates the whole apparatus as the printer 10 according to the present invention.

The NVRAM 14 is a nonvolatile memory, and stores function information contained in the printer 10, and image data inputted from the outside via an I/O interface (not shown), for example.

The operating section 15 is provided with a touch panel or a numeric keypad, or the like, which accepts by a user's operation an instruction for controlling an operation of the printer 10, such as a setup instruction for setting up a function of the printer 10.

The printing section 16 reads image data stored in the NVRAM 14, for example, and forms an image based on the image data on a record sheet, such as a sheet of paper, by a method, such as a heat transfer method, an electro-photographic method, or an inkjet method.

The printer 10 is provided with a network card or a modem (not shown) etc., and transmits and receives data to and from the display apparatus 20 via a communication line L1.

On the other hand, the scanner 30 is provided with a CPU 31 (instructing section), a ROM 32, a RAM 33, an HDD 34, an operating section 35, an image input section 36, and an image processing section 37. The CPU 31, the ROM 32 and the RAM 33 of the scanner 30 are the same as those of the printer 10, and detailed description thereof is omitted.

The HDD 34 stores various programs, such as an OS, application software for reading image data, a driver for controlling the image input section 36, etc.

The operating section 35 is provided with a plurality of buttons, and permits various kinds of input operations, such as an instruction to start a scan by a user.

The image input section 36 reads an image of a document optically. That is, the image input section 36 is provided by a color scanner comprising a photosensor, such as a CCD (Charge Coupled Device), decomposes an optical image reflected from a document that a color image is recorded on a record sheet, such as a sheet of paper into respective colors of an RGB (R: Red, G: Green, B: Blue), reads them by the photosensor, converts them into analog signals of the RGB, and outputs the analog signals of the RGB to the image processing section 37.

The image processing section 37 converts the analog signals inputted from the image input section 36 into digital signals, and processes them properly. The image data processed in this manner is stored in the HDD 34 or the RAM 33.

The scanner 30 is provided with a network card or a modem (not shown) etc., and is connected to the display apparatus 20 via a communication line L2. Therefore, image data stored in the HDD 34 or the RAM 33 is outputted to the display apparatus 20 via the communication line L2, and the display apparatus 20 displays an image based on the image data.

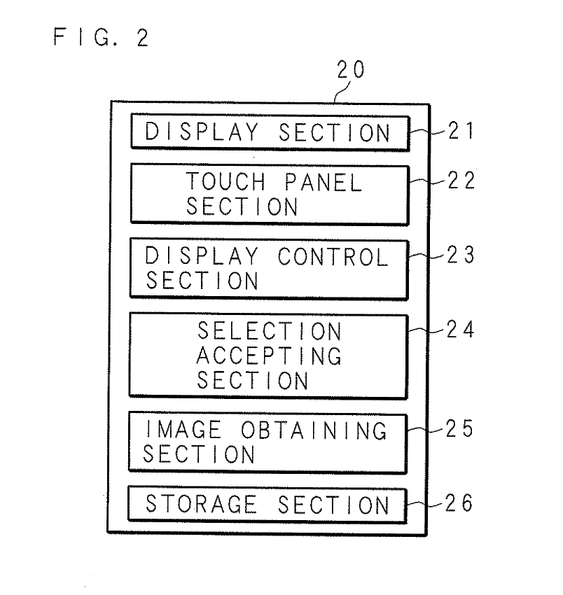

On the other hand, FIG. 2 is a functional block diagram showing an essential configuration of the display apparatus 20 of the display system 1 according to Embodiment 1 of the present invention. The display apparatus 20 comprises a display section 21, a touch panel section 22, a display control section 23, a selection accepting section 24, an image obtaining section 25, and a storage section 26.

The display section 21 is provided by an LCD panel or an EL (Electroluminescence) panel, for example. The display section 21 displays a menu screen (function display screen) representing functions contained in the printer 10 and the scanner 30, such as “print” and “scan”, a menu soft key for accepting an instruction to display the menu screen, an image based on image data obtained from the scanner 30, i.e., an image of a document read by the scanner 30, and the like. The touch panel section 22 is provided so as to cover a display screen of the display section 21.

The touch panel section 22 is provided so as to cover the display screen of the display section 21. The touch panel section 22 accepts a specification of a position on the display screen of the display section 21 by a touch operation of a user's fingertip. The touch panel section 22 senses change of pressure by a touch operation of a user's fingertip, or senses an electric signal according to static electricity, detects coordinates on the display screen of the display section 21 corresponding to a contact point where a user's fingertip contacts, and creates a signal identifying the coordinates.

The display control section 23 is provided by a processor like a DSP (Digital Signal Processor), and controls the displaying an image on the display section 21. For example, the display control section 23 controls a display of an image based on image data obtained from the scanner 30, a display of the menu image, and the like. When the selection accepting section 24 accepts selection of a predetermined function, the display control section 23 displays an image concerning the execution of the function.

For example, when the menu screen is displayed on the display section 21 and a user touches any one of the functions on the menu screen with a fingertip to select the function, the touch panel section 22 detects coordinates on the display screen of the display section 21 corresponding to a contact point of the user's fingertip, and sends a signal identifying the coordinates to the selection accepting section 24.

The selection accepting section 24 obtains the signal (coordinates) from the touch panel section 22, and recognizes that a function of a position corresponding to the coordinates is selected among the functions on the menu screen displayed on the display section 21. Thus, the selection accepting section 24 can accept selection from a user.

The image obtaining section 25 obtains image data to be displayed on the display section 21 from any one of the printer 10 or the scanner 30, based on selection accepted by the selection accepting section 24.

For example, when a user touches “print” of the menu screen and thereby the selection accepting section 24 accepts selection of “print”, the image obtaining section 25 obtains image data from the printer 10 having a “print” function. On the other hand, when a user touches “scan” of the menu screen and thereby the selection accepting section 24 accepts selection of “scan”, the image obtaining section 25 switches a source for obtaining image data, and obtains image data from the scanner 30 having a “scan” function.

The storage section 26 includes a nonvolatile storage medium, such as a flash memory, an EEPROM, an HDD, a MRAM (magneto-resistance memory), an FeRAM (ferroelectric memory), or an OUM, for example. The storage section 26 stores image data concerning the menu screen, and the like.

The display apparatus 20 is provided with a network card or a modem (not shown) etc., is connected to the printer 10 via the communication line L1 and is connected to the scanner 30 via the communication line L2, respectively.

The display control section 23, the selection accepting section 24, and the image obtaining section 25 of the display apparatus 20 as described above may be configured as a hardware logic device or as software.

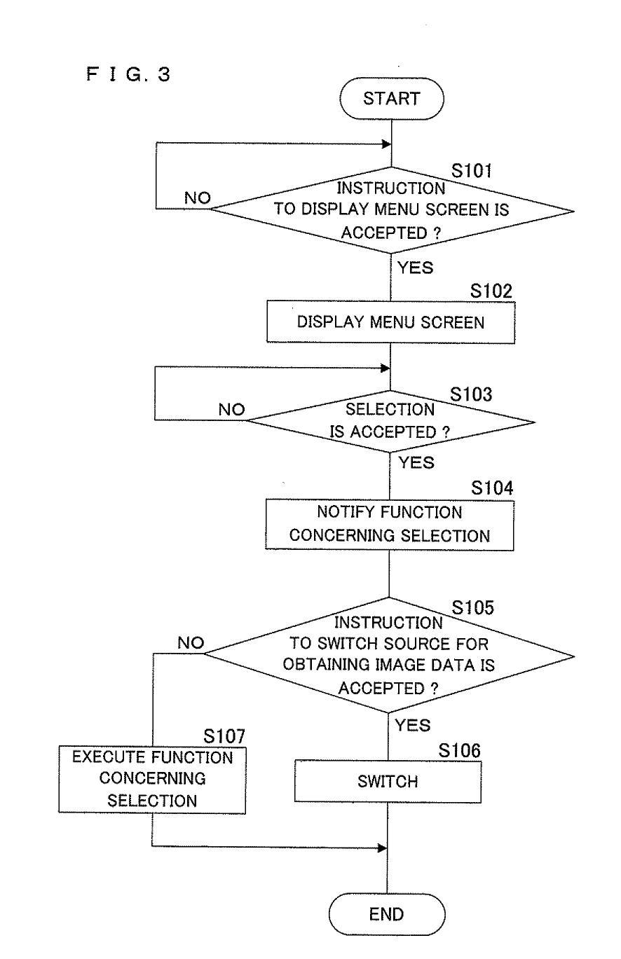

FIG. 3 is a flow chart explaining how to obtain image data in the display system 1 according to Embodiment 1 of the present invention. For convenience of description, the following description explains, as an example, the case in which the image obtaining section 25 of the display apparatus 20 obtains image data from the printer 10 at the moment, but selection of a “scan” function is accepted via the menu screen, and a source for obtaining image data is switched.

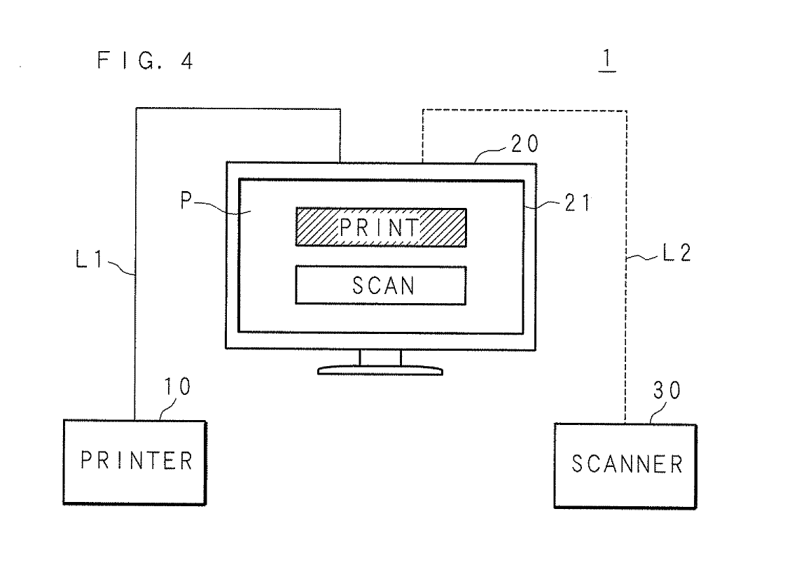

FIG. 4 is an explanatory diagram showing a case in which the image obtaining section 25 of the display apparatus 20 obtains image data from the printer 10 in the display system 1 according to Embodiment 1 of the present invention. FIG. 4 shows that “print” of a menu screen P is selected at the moment, and that the printer 10 is a source for obtaining image data by the representation of the communication line L1 between the printer 10 and the display apparatus 20 with a solid line. Also, FIG. 4 shows that the scanner 30 is not a source for obtaining image data at the moment by the representation of the communication line L2 between the scanner 30 and the display apparatus 20 with a dotted line.

As described above, the printer 10 is a source for obtaining image data at the moment, and a user who desires to scan a document touches the menu soft key properly, and instructs to display a menu screen.

In this case, the display control section 23 monitors a signal sent from the touch panel section 22 to determine whether or not an instruction to display the menu screen is accepted (Step S101). When the display control section 23 determines that the instruction to display the menu screen is not accepted (Step S101: NO), the display control section 23 repeats such a determination until the instruction is accepted.

On the other hand, when the display control section 23 determines that the instruction to display the menu screen is accepted (Step S101: YES), the display control section 23 displays the menu screen P on the display section 21 based on image data for the menu screen stored in the storage section 26 (Step S102).

Subsequently, the display control section 23 monitors the selection accepting section 24 to determine whether or not selection of any one of the functions is accepted (Step S103). When the display control section 23 determines that the selection of any one of the functions is not accepted (Step S103: NO), the display control section 23 repeats such a determination until the selection of any one of the functions is accepted.

On the other hand, when the display control section 23 determines that the selection of any one of the functions is accepted (Step S103: YES), that is, when the selection accepting section 24 accepts the selection of any one of the functions, the display control section 23 (notifying section) notifies a current source for obtaining image data, of the function concerning the selection accepted by the selection accepting section 24 (Step S104).

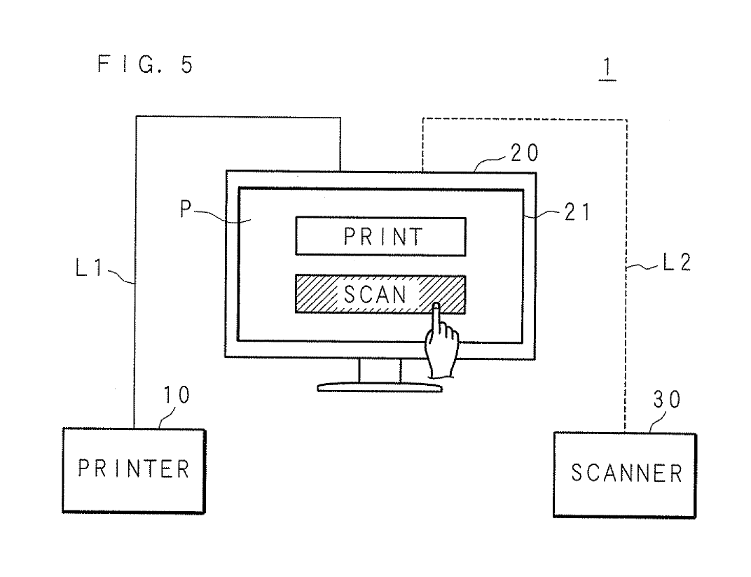

FIG. 5 is a diagram showing an operation of selecting a function on the menu screen P in Embodiment 1 of the present invention. For example, in a case where a source for obtaining image data is the printer 10 at the moment when a user selects “scan” of the menu screen P, the display control section 23 notifies the printer 10 that a “scan” function is selected, via the communication line L1.

When the printer 10 accepts such a notification, the CPU 11 of the printer 10 determines whether or not a function concerning the accepted notification is its own function, based on function information of the printer 10 stored in the NVRAM 14.

Here, since the “scan” function is not a function of the printer 10, the CPU 11 (instructing section) of the printer 10 transmits an instruction to stop obtaining image data and switch a source for obtaining image data to the display apparatus 20 via the communication line L1.

That is, in the display system according to the present invention, an electric device corresponding to a current source for obtaining image data gives an instruction to switch a source for obtaining image data, thereby unexpected switching by other electric device can be prevented from occurring.

In this case, the display control section 23 of the display apparatus 20 monitors the communication line L1 to determine whether or not an instruction to switch a source for obtaining image data is accepted (Step S105).

When the display control section 23 determines that the instruction to switch a source for obtaining image data is not accepted for a predetermined period of time, for example (Step S105: NO), in other words, when a source for obtaining image data determines that a function concerning the accepted notification is its own function, a current source for obtaining image data is not changed, and the current source for obtaining image data executes the accepted function (Step S107).

On the other hand, when the display control section 23 determines that the instruction to switch a source for obtaining image data is accepted (Step S105: YES), the display control section 23 instructs the image obtaining section 25 to switch a source for obtaining image data.

That is, since the “scan” function is not a function of the printer 10 and hence an instruction to switch a source for obtaining image data is transmitted from the printer 10 to the display apparatus 20 in the present Embodiment, the image obtaining section 25 switches a source for obtaining image data from the printer 10 to the scanner 30 according to the instruction (Step S106). The display control section 23 notifies the scanner 30 that the “scan” function is selected, via the communication line L2.

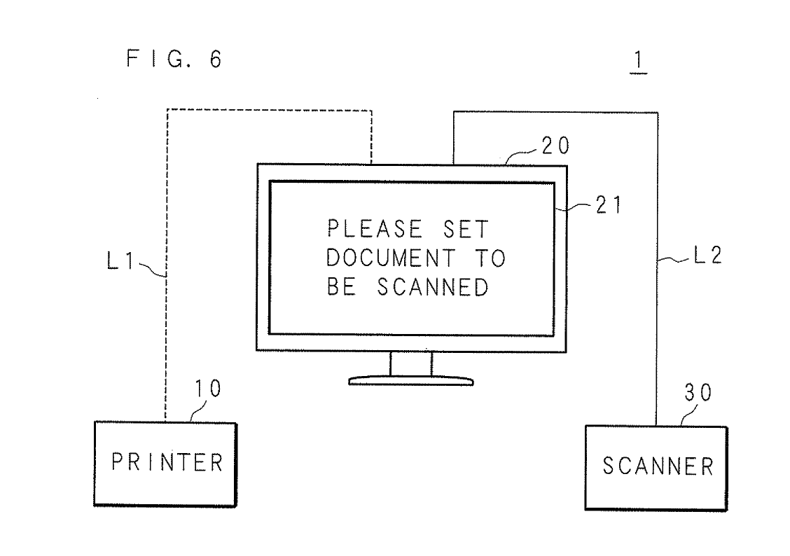

The scanner 30 which has accepted the notification transmits image data for displaying an image concerning the execution of the accepted function to the display apparatus 20 via the communication line L2, and as shown in FIG. 6, an image based on the image data is displayed on the display section 21.

As described above, in the display system according to the present invention, a user uses one display apparatus 20 (display section 21) in order to execute jobs concerning the printer 10 and the scanner 30 which are spatially arranged separately from each other, and the user can save time and effort to move to positions at which the electronic devices are arranged, respectively.

Moreover, even when a source for obtaining image data is switched between the printer 10 and the scanner 30, an uncomfortable feeling is not given to a user, since the user does not realize such a switching.

Note that, although the case in which the printer 10 and the scanner 30 are arranged separately from the display apparatus 20 is explained as an example in the above description, it is not limited to this. For example, the printer 10 and the display apparatus 20 may be integrally configured as a so-called kiosk (KIOSK).

Moreover, the display control section 23, the selection accepting section 24, and the image obtaining section 25 of the display apparatus 20 may be provided in the printer 10 or the scanner 30.

### Embodiment 2

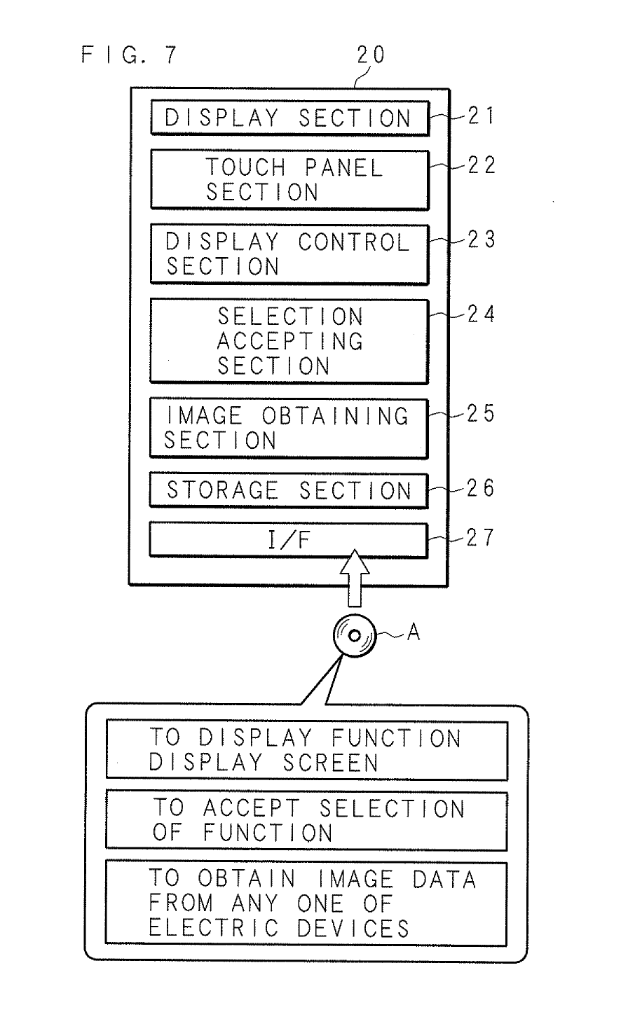

FIG. 7 is a functional block diagram showing an essential configuration of a display apparatus 20 of a display system 1 according to Embodiment 2 of the present invention. The display apparatus 20 of Embodiment 2 is configured so that a computer program for operation is capable of being provided by a removable recording medium A, such as a CD-ROM, through an I/F 27. Moreover, the display apparatus 20 of Embodiment 2 is configured so that the computer program is capable of being downloaded from an external device (not shown) through a communication section (not shown). The contents will be explained below.

The display apparatus 20 of Embodiment 2 comprises an external (or internal) recording medium reader (not shown). The removable recording medium A, which stores a program for causing the display section 21 to display the menu screen (function display screen); accepting selection of any one of functions via the function display screen; causing the image obtaining section 25 to obtain image data from any one of electric devices based on the accepted selection, is inserted into the recording medium reader, and for example, the display control section 23 installs the program in the storage section 26. Consequently, it functions as the display apparatus 20 of Embodiment 2 of the present invention.

The same parts as in Embodiment 1 are designated with the same reference numbers, and detailed explanation thereof will be omitted.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. A display system comprising a plurality of electric devices spatially separated from each other, and a display section which displays images based on image data obtained from the electric devices, wherein
the display section displays a function display screen representing functions of the plurality of electric devices,
the display system further comprises:
a selection accepting section which accepts selection of any one of the functions through the function display screen; and
an image obtaining section which is located between the display section and the plurality of electric devices, and obtains image data from any one of the electric devices based on the selection accepted by the selection accepting section.

2. The display system according to claim 1, further comprising a notifying section which notifies the electric device from which the image obtaining section obtains image data at the moment, of the function concerning the selection accepted by the selection accepting section, wherein
each of the electric devices is provided with an instructing section which instructs the image obtaining section to stop obtaining image data when the electric device accepts the notification and the notification does not correspond to its own function.

3. A display system comprising a plurality of electric devices spatially separated from each other, and a display section which displays images based on image data obtained from the electric devices, wherein
the display section displays a function display screen representing functions of the plurality of electric devices, the display system further comprises:
selection accepting means which accepts selection of any one of the functions through the function display screen; and
an image obtaining section which is located between the display section and the plurality of electric devices, and obtains image data from any one of the electric devices based on the selection accepted by the selection accepting means.

4. The display system according to claim 3, further comprising notifying means which notifies the electric device from which the image obtaining section obtains image data at the moment, of the function concerning the selection accepted by the selection accepting means, wherein
each of the electric devices is provided with instructing means which instructs the image obtaining section to stop obtaining image data when the electric device accepts the notification and the notification does not correspond to its own function.

5. A method of obtaining image data to be displayed in a display system comprising a plurality of electric devices spatially separated from each other, a display section which displays images based on image data obtained from the electric devices, and an image obtaining section which is located between the display section and the plurality of electric devices and obtains image data from any one of the electric devices, said method comprising:
a step of displaying a function display screen representing functions of the plurality of electric devices on the display section;
a selection accepting step of accepting selection of any one of the functions through the function display screen; and
a step of the image obtaining section obtaining image data from any one of the electric devices, based on the selection accepted at the selection accepting step.

6. A non-transitory computer-readable recording medium in which a computer program is recorded, the computer program causing, to obtain image data to be displayed, a computer constituting a display system comprising a plurality of electric devices spatially separated from each other, a display section which displays images based on image data obtained from the electric devices, and an image obtaining section which is located between the display section and the plurality of electric devices and obtains image data from any one of the electric devices, said computer program comprising:
a step of causing the computer to display a function display screen representing functions of the plurality of electric devices on the display section;
a selection accepting step of causing the computer to accept selection of any one of the functions through the function display screen; and
a step of causing the computer to obtain image data through the image obtaining section from any one of the electric devices, based on the selection accepted at the selection accepting step.
